(19) United States
(12) Patent Application Publication
(10) Pub. No.: US 2004/0188594 A1
(43) Pub. Date: Sep. 30, 2004

(54) Spectrally tunable solid-state light source

(76) Inventors: Steven W. Brown, Washington Grove, MD (US); B. Carol Johnson, Gaithersburg, MD (US); George P. Eppeldauer, Montgomery Village, MD (US)

Correspondence Address: STITES & HARBISON PLLC, 1199 NORTH FAIRFAX STREET, SUITE 900, ALEXANDRIA, VA, 22314, US

(21) Appl. No.: 10/836,191

(22) Filed: May 3, 2004

Related U.S. Application Data
(60) Provisional application No. 60/467,236, filed on May 1, 2003.

(51) Int. Cl. G01J 1/32; G01J 3/28

(52) U.S. Cl. 250/205; 250/228; 356/236; 356/326

(57) ABSTRACT

A radiometrically stable, spectrally tunable, solid-state source combines the radiometric outputs of individually controlled, narrow bandwidth, solid-state sources (e.g., LEDs) with different spectral distributions in an integrating sphere so as to approximate any desired spectral distribution. By using a sufficient number of independent solid-state source channels, the source can be tuned to approximate the spectral distribution of any desired source distribution. A stable reference spectroradiometer, integrated into the solid-state light source, measures the spectral radiance or irradiance and is used to adjust the output of the individual channels of the individually controlled sources.

### CROSS REFERENCE TO RELATED APPLICATIONS

This application claims benefit of U.S. Provisional Application No. 60/467,236, filed May 1, 2003.

### FIELD OF THE INVENTION

The present invention relates to light sources used, for example, as a reference in the calibration of light-measuring instruments and for other purposes, and, more particularly, to spectrally tunable light sources.

### RELATED ART

At present, the primary technology used for the broad purposes of the invention is the lamp-illuminated source. Generally speaking, tungsten quartz halogen lamps are used. The spectral distribution of these sources is fixed, having a Planckian distribution with an effective temperature around 2856 K, which does not produce the required flux in the UV and blue spectral regions for many applications. Arc sources (e.g., Xe) are sometimes used, but the temporal stability is generally inadequate for use as a calibration artifact.

A source using light emitting diodes (LEDs) is made by Gamma Scientific but this source is limited in that a target spectrum cannot be input or realized.

The National Physical Laboratory of the U.K. has developed a tunable source that uses a liquid crystal array for spectral selectivity and a conventional lamp-based illumination source. This tunable source has a desirable spectral selectivity, but the flux levels are several orders of magnitude lower than can be provided by the solid-state source of the invention, and are too low to be of use in many applications. Moreover, the flux levels cannot be increased, since these levels are limited by the particular illumination technology used.

In general, conventional sources are inadequate for the purposes of the present invention because (1) such conventional sources have a fixed spectral distribution that differs significantly from the desired spectral distribution, (2) they are not sufficiently spectrally tunable, and (3) they often do not have sufficient flux in certain spectral ranges (e.g., UV for tungsten-lamp illuminated integrated sphere sources).

### SUMMARY OF THE INVENTION

In accordance with one aspect of the invention, a spectrally tunable light source is provided which improves the calibration uncertainly associated with conventional sources and which affords a number of advantages over the prior art. For example, the light source of the invention can approximate the spectral distributions of a variety of artificial sources (e.g., CIE standard illuminant A, D65 and D55, gas discharge lamps, CRTs, LED and other of displays, etc.) as well as a variety of natural light sources (e.g., solar flux, water-leaving radiance, earth reflectance, etc.). The single source of the invention can approximate the spectral distributions for a wide variety of conventional sources, thereby eliminating the need to maintain large groups of standard sources. In addition, the source can approximate non-standard spectral distributions unattainable by any other commercially available source. By mimicking specific spectral distributions, measurement errors arising from stray light, wavelength error and the like can be greatly reduced or eliminated.

In accordance with one aspect of the invention, there is provided a spectrally tunable solid-state source comprising:

an integrating sphere having a plurality of ports;

a plurality of individually controllable solid-state illumination sources with different spectral distributions mounted on the integrating sphere at a plurality of said ports so as to direct radiation into the sphere such that the integrating sphere integrates said spectral distributions and produces integrated radiation based thereon;

output means connected to an exit port of said integrating sphere for producing an output related to the integrated radiation produced by the integrating sphere; and

control means for receiving said output and for controlling, based on said output, the solid-state illumination sources to vary said output.

Preferably, the output means comprises a reference spectroradiometer. In one embodiment, the spectroradiometer measures the integrated radiation in the plane of the exit port. In an alternative embodiment, the spectroradiometer measures the integrated radiation at a given distance from said exit port.

Preferably, the solid-state light sources comprise light emitting diodes. In a preferred implementation, the source further comprises a power supply for controlling the light emitting diodes, the power supply being controllable by said control means. Advantageously, the diodes are grouped in channels and the power supply comprises a multi-channel power supply for controlling groups of the diodes to control the radiometric outputs thereof. In one important implementation, the multi-channel power supply individually controls the radiometric outputs of individual diodes. Preferably, the control means stores desired spectral distributions, compares a spectral distribution based on the output of the output means (e.g., spectroradiometer) with one of the desired spectral distributions stored thereby to detect differences therebetween, and controls said power supply, and thus the light emitting diodes, based on the differences.

Preferably, the solid-state sources produce radiation having different narrow bandwidth spectral distributions which, when integrated together, produce an integrated wide bandwidth spectral distribution. Advantageously, the solid-state sources include light emitting diodes which emit blue and ultraviolet light.

More generally, in accordance with a preferred embodiment, the control means stores desired spectral distributions, compares a spectral distribution based on the output of said output means (e.g., spectroradiometer) with one of the desired spectral distributions stored thereby to detect differences therebetween and controls said controllable solid-state illumination sources based on these differences.

According to a further aspect of the invention, there is provided a spectrally tunable solid-state source comprising:

an integrating sphere having a plurality of ports;

a plurality of individually controllable solid-state illumination sources with different narrow bandwidth spectral distributions mounted on the integrating sphere at a plurality of said ports so as to direct radiation into the sphere such that the integrating sphere integrates the different spectral distributions and produces, based thereon, integrated radiation of an integrated wide bandwidth spectral distribution;

a reference spectroradiometer connected to an exit port of said integrating sphere for producing an output related to the integrated radiation produced by the integrating sphere; and

control means for storing desired spectral distributions, for receiving said output, for comparing a spectral distribution based on said output with one of the desired spectral distributions stored thereby to detect differences therebetween, and for controlling the solid-state illumination sources based on said differences.

Further features and advantages of the present invention will be set forth in, or apparent from, the detailed description of preferred embodiments thereof which follows.

### BRIEF DESCRIPTION OF THE DRAWINGS

FIG. 1 is a schematic diagram of a spectrally tunable solid-state source in accordance with one preferred embodiment of the invention.

### DESCRIPTION OF THE PREFERRED EMBODIMENTS

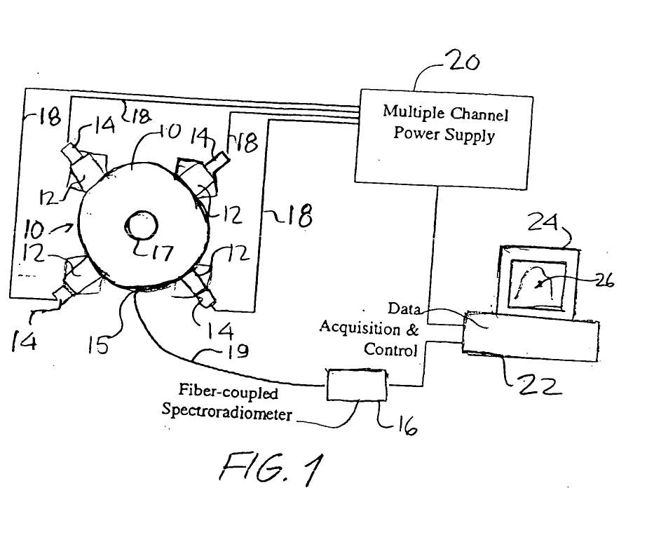

Referring to FIG. 1, there is shown a schematic diagram of a simplified tunable solid-state source or system in accordance with one embodiment of the invention. The source or system includes a conventional integrating sphere 10 having a plurality of mounting ports 12 mounted in the walls of sphere 10 (with four such ports 12 being shown in FIG. 1). A plurality of individually controllable light sources, preferably in the form of heads 14 of individual controllable light emitting diodes (LEDs), is coupled to the ports 12.

Although it will, of course, be understood that other integrating spheres can be used as sphere 10, by way of background, it is noted that, in a specific non-limiting example, the sphere used is a 30 cm diameter sphere coated with barium sulfate and, as indicated above, with four ports 12 for the LED heads 14. The sphere 10 further includes one port 15 for a reference spectroradiometer 16 described in more detail below, and one exit port 17. Barium sulfate is a white, diffuse, readily available coating with reasonable reflectance over much of the desired spectral range. However, it will be appreciated that coatings other than barium sulfate can be used. In the non-limiting example under consideration, the ports 12 for the LED heads 14 are 50.8 mm in diameter and are disposed around the exit port 17, which is itself 70 mm in diameter. In this embodiment, the port 15 to which the reference spectroradiometer 16 is coupled is a 10 mm port, and coupling is effected using a fiber optic cable 19.

In a specific, non-limiting example, forty individually controllable LED channels are used with approximately three LEDs per channel. In the exemplary embodiment under consideration, ten channels are grouped into the four heads 14 mounted in the four ports 12 of integrating sphere 10. It is noted that other illumination geometries, i.e., other than those employing individual heads, can also be used. However, in this embodiment, the individual LED heads 14 are populated with plural LEDs selected and grouped according to the desired results. In this non-limiting example, the same type of LEDs (i.e., LEDs from the same vendor and having the same model number) are preferably used.

Each of the groups of channels of LEDs is connected by four channel connections 18 to a multiple channel power supply 20. The power supply 20 can be used in either a manual or remote control controlled mode and can be set for either a constant current or a constant voltage output. In a preferred embodiment, the channels of LEDs are operated at programmable and continuously variable drive currents. In the specific, non-limiting embodiment under consideration, the emission wavelengths for the LEDs in each head 14 are selected so that the spectral distribution provided by the LEDs is limited to a particular range of colors for that head, thus providing a variable spectral distribution with a nominal color (e.g., blue, turquoise, green, yellow, etc.) for each head 14. Such spectral variability can be achieved by adjusting the drive currents for different channels in a particular head 14.

The LEDs used as light sources in heads 14 can comprise commercial LEDs with full-width, half maximum bandwidths on the order of 20 nm. The peak emission wavelengths for these LEDs are separated by about 5 nm. In a specific, non-limiting example, the LEDs each channel are connected in parallel and operated using an external power supply corresponding to power supply 20. It will be understood that the LEDs in each channel can also be connected in series, and that other light sources can also be used. Stability testing carried out with respect to a variety of red, green and blue LEDs indicated changes in the radiometric output on the order of 0.1% over 250 hours of use a mid-range drive current. Commercially available sources have stated radiometric stabilities on the order of 1% per year down to 360 nm.

Returning to a discussion of the overall system, a data acquisition and control unit 22 including a display 24 is connected to the input of multiple channel power supply 20 and to the output of the spectroradiometer 16. Display 24 displays the realized or output spectrum which is represented by a spectrum denoted 26 in FIG. 1.

The reference spectroradiometer 16, which, as noted above, is connected to an exit port of the integrating sphere 10 (port 15 in the illustrated embodiment), measures the spectrally tuned integrated (that is, sphere averaged—providing a diffuse, unpolarized, lambertian, uniform) radiation. Measurements are provided by spectroradiometer 16 of the integrated radiation either in the plane of one of the exit ports of the sphere 10 (i.e., the tunable source radiance) and/or from one of the sphere exit ports (the tunable irradiance at a given distance). In this embodiment, the reference spectroradiometer 16 is oriented to view a portion of the back wall of sphere 10 as seen through the output port. The reference spectroradiometer 16 is preferably built-in and preferably comprises a single-grating, fiber-coupled, linear photodiode array spectrograph. During the operation of the solid-state light source of FIG. 1, the output of spectroradiometer 16 provides the spectral radiance of the particular configuration (i.e., for the particular drive current levels for all of the channels) from 360 nm to 800 nm. In addition, the output of the spectroradiometer 16 is preferably used to achieve preset spectral radiance values by incorporating a control loop algorithm.

As indicated above, the operation of the solid-state light source is controlled by a computer program which resides in a computer in data and acquisition unit 22. Unit 22 stores reference spectra, as well as calibration information (wavelength counts/spectral radiance) and, in a preferred embodiment, a chi-squared variable is derived using the observed spectra (obtained from spectroradiometer 16) and the reference spectra (i.e., the desired spectra) and the drive currents for the LEDs of LED heads 14 are adjusted to minimize the difference of the two spectra.

In a specific non-limiting example, a source as configured in FIG. 1 was used to approximate the spectral distribution of water leaving radiance in waters with widely varying chlorophyll concentrations. A comparison of the solid-state source output with the target spectral distributions for blue, blue-green and green waters showed reasonable agreement over most of the spectral range, and it is believed that improvements with respect to the coating used and the particular LEDs employed at some wavelengths will result in even better agreement.

It will be appreciated from the foregoing that the invention has a number of important aspects and provides a number of important advantages. For example, the use of a single source constructed with a plurality of solid-state light sources (preferably LEDs) enables varied spectral distributions to be generated. Further, the incorporation of new ultraviolet and blue LEDs results in a source that has adequate flux in this spectral region to enable approximating of blue spectral sources such as water-leaving radiance (as described in the foregoing example). The provision of an integrated, calibrated spectroradiometer and, in a preferred embodiment, the use of a feedback control algorithm, result in operation at predetermined spectral radiance distributions that mimic both artificial and natural radiometric sources. In addition, the range of allowed spectral radiance distributions is flexible. Further, in many cases, the solid-state source will reduce the calibration uncertainties over those of traditional lamp-based spectral source standards. It should be noted that the solid sate source of the invention can be used in conjunction with lamp-based standards, without detailed knowledge of the relative sensor's relative spectral responsivity, in order to reduce the calibration and operational uncertainties. Although the invention is not limited to the use of LEDs, LEDs provide important advantages in that they are small, rugged, robust, stable, low power, and do not produce large thermal loads. As a consequence, the solid-state light source of the invention, particularly when implemented using LEDs, is ideal for field applications.

It will also be understood that the solid-state source of the invention has many applications including a number of commercial applications. For example, the solid-state source has commercial potential as a simulator for a wide variety of disparate sources. The solid-state source can be used as a standard radiometric source and/or as a transfer artifact. The source can be used to replace many conventional source types and, as indicated above, can be used to generate new spectral distributions that cannot be approximated by any currently available technology. Thus, the source can be used to rapidly calibrate an instrument against a variety of differing spectral distributions (e.g., infrared for night vision detectors, different types of lamps, different types of water-leaving radiance distributions, and the like). In this regard, the tunable source can be designed for colorimetry and used to mimic the spectral distributions of color standards or displays, thereby enabling rapid calibration of instruments that measure colorimetric or photometric quantities.

The solid-state source is also suitable for field measurements and calibrations or as a stability monitor of instrument performance. There is a significant potential application of such a solid-state source in remote sensing in that most sensors are uncharacterized for environmental effects (e.g., ambient temperature, air pressure, humidity) and yet these sensors are operated over a range of conditions, including at high altitude, on aircraft, and for long intervals of time, aboard ship. With respect to use thereof as a field source, it is noted that the source, as implemented using LEDs, consumes on the order of 1% of the power used by traditional tungsten sources.

Although the invention has been described above in relation to preferred embodiments thereof, it will be understood by those skilled in the art that variations and modifications can be effected in these preferred embodiments without departing from the scope and spirit of the invention.

What is claimed:

1. A spectrally tunable solid-state source comprising:
an integrating sphere having a plurality of ports;
a plurality of individually controllable solid-state illumination sources with different spectral distributions mounted on the integrating sphere at a plurality of said ports so as to direct radiation into the sphere such that the integrating sphere integrates said spectral distributions and produces integrated radiation based thereon;
output means connected to an exit port of said integrating sphere for producing an output related to the integrated radiation produced by the integrating sphere; and
control means for receiving said output and for controlling, based on said output, the solid-state illumination sources to vary said output.

2. A source as defined in claim 1 wherein said output means comprises a reference spectroradiometer.

3. A source as defined in claim 2 wherein said spectroradiometer measures the integrated radiation in the plane of the exit port.

4. A source as defined in claim 2 wherein the spectroradiometer measures the integrated radiation at a given distance from said exit port.

5. A source as defined in claim 1 wherein the solid-state light sources comprise light emitting diodes.

6. A source as defined in claim 5 further comprising a power supply for controlling said light emitting diodes, said power supply being controllable by said control means.

7. A source as defined in claim 6 wherein said diodes are grouped in channels and wherein said power supply comprises a multi-channel power supply for controlling groups of said diodes to control the radiometric outputs thereof.

8. A source as defined in claim 7 wherein said multi-channel power supply individually controls the radiometric outputs of individual diodes.

9. A source as defined in claim 6 wherein control means stores desired spectral distributions, compares a spectral distribution based on the output of said output means with one of the desired spectral distributions stored thereby to detect differences therebetween, and controls said power supply, and thus said light emitting diodes, based on said differences.

10. A source as defined in claim 1 wherein said solid-state sources produce radiation having different narrow bandwidth spectral distributions which, when integrated together, produce an integrated wide bandwidth spectral distribution.

11. A source as defined in claim 10 wherein said solid-state sources include light emitting diodes which emit blue and ultraviolet light.

12. A source as defined in claim 1 wherein said control means stores desired spectral distributions, compares a spectral distribution based on the output of said output means with one of the desired spectral distributions stored thereby to detect differences therebetween and controls said controllable solid-state illumination sources based on said differences.

13. A spectrally tunable solid-state source comprising:
an integrating sphere having a plurality of ports;
a plurality of individually controllable solid-state illumination sources with different narrow bandwidth spectral distributions mounted on the integrating sphere at a plurality of said ports so as to direct radiation into the sphere such that the integrating sphere integrates the different spectral distributions and produces, based thereon, integrated radiation of an integrated wide bandwidth spectral distribution;
a reference spectroradiometer connected to an exit port of said integrating sphere for producing an output related to the integrated radiation produced by the integrating sphere; and
control means for storing desired spectral distributions, for receiving said output, for comparing a spectral distribution based on said output with one of the desired spectral distributions stored thereby to detect differences therebetween, and for controlling the solid-state illumination sources based on said differences.

14. A source as defined in claim 13 wherein said spectroradiometer measures the integrated radiation in the plane of the exit port.

15. A source as defined in claim 13 wherein the spectroradiometer measures the integrated radiation at a given distance from said exit port.

16. A source as defined in claim 13 wherein the solid-state light sources comprise light emitting diodes.

17. A source as defined in claim 16 further comprising a power supply for controlling said light emitting diodes, said power supply being controllable by said control means.

18. A source as defined in claim 17 wherein said diodes are grouped in channels and wherein said power supply comprises a multi-channel power supply for controlling groups of said diodes to control the radiometric outputs thereof.

19. A source as defined in claim 18 wherein said multi-channel power supply individually controls the radiometric outputs of individual diodes.

20. A source as defined in claim 16 wherein said solid-state sources include light emitting diodes which emit blue and ultraviolet light.
